(19) United States
(12) Patent Application Publication
(10) Pub. No.: US 2007/0298884 A1
(43) Pub. Date: Dec. 27, 2007

(54) GAME DEVICE

(76) Inventor: Laisuo Li, SHENZHEN (CN)

Correspondence Address: Eric Chan, 42 Pin Oaks Drive, Phoenixville, PA, 19460, US

(21) Appl. No.: 11/423,450

(22) Filed: Jun. 12, 2006

(51) Int. Cl. A63F 13/00

(52) U.S. Cl. 463/37

(57) ABSTRACT

A game device includes an enclosure, a first key, and a second key. The enclosure defines a first through-hole, and a second through-hole adjacent the first through hole in a surface thereof. The first key is received in the first through-hole. A top of the first key is higher than the surface of the enclosure. The second key is received in the second through-hole. A top of the second key is lower than the surface of the enclosure.

### BACKGROUND OF THE INVENTION

The present invention relates to game devices, and particularly to a game device having controlling keys.

Generally, there are a plurality of controlling keys mounted to an enclosure of a typical game device, such as start key, pause key, quit key, etc. Typically, the controlling keys are mounted in a little area of the enclosure, and protruding out from the enclosure about 1˜2 mm. When a user operates a controlling key, other controlling keys may be touched, which may lead to abnormal work. Sometimes, a game program will quit when several controlling keys are simultaneously operated.

What is needed is to provide a game device which easily avoid controlling keys of the game device being mistakenly touched.

### BRIEF SUMMARY OF THE INVENTION

An exemplary game device includes an enclosure, a first key, and a second key. The enclosure defines a first through-hole, and a second through-hole adjacent the first through hole in a surface thereof. The first key is received in the first through-hole. A top of the first key is higher than the surface of the enclosure. The second key is received in the second through-hole. A top of the second key is lower than the surface of the enclosure.

Other objects, advantages and novel features of the invention will become more apparent from the following detailed description when taken in conjunction with the accompanying drawings, in which:

### BRIEF DESCRIPTION OF THE DRAWINGS

FIG. 1 is a front side view of a game device in accordance with a preferred embodiment of the present invention;

FIG. 2 is a cross-sectional view taken along the line A-A in FIG. 1;

FIG. 3 is an enlarged view of a circle B in FIG. 2; and

FIG. 4 is a front side view of a game device in accordance with an alternative embodiment of the present invention.

### DETAILED DESCRIPTION OF THE INVENTION

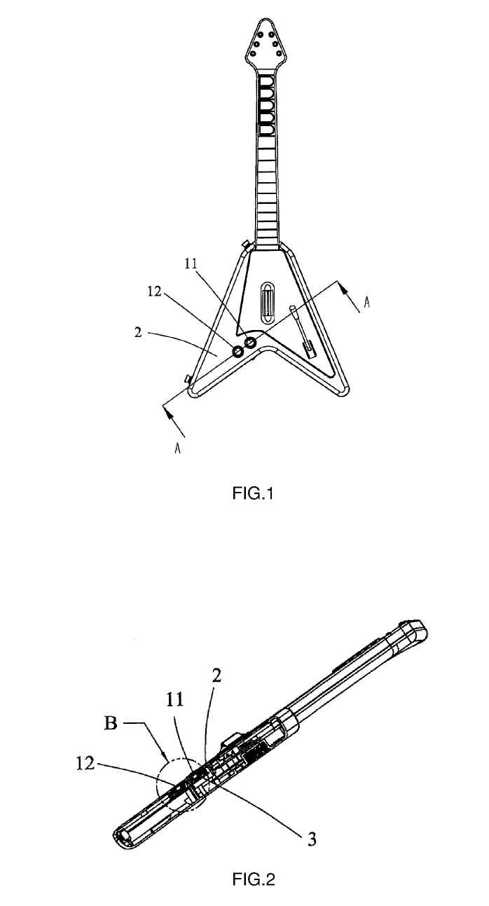

Referring to FIG. 1, a game device in accordance with a preferred embodiment of the present invention is shown. The game device in this preferred embodiment is a simulating musical instrument game. The game device includes an enclosure 2, a circuit board 3 mounted in the enclosure 2, and two keys 11, 12, such as a select key and a start key. A top of the key 11 is higher than that of a surface of the enclosure 2. A top of the key 12 is not higher than that of the surface of the enclosure 2. In this embodiment, the top of the key 12 is aligned with the surface of the enclosure 2.

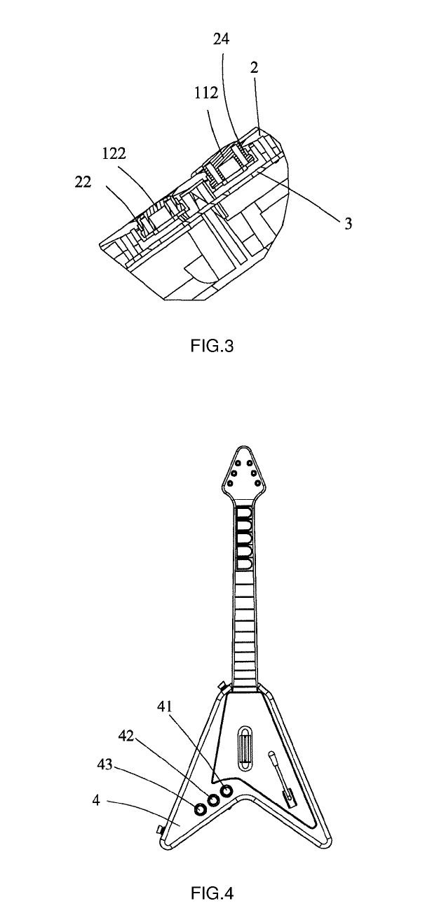

Referring also to FIGS. 2 and 3, two through-holes 22, 24 are defined in the surface of the enclosure 2. Each key of the keys 11, 12 includes a switch electrically connected to the circuit board 3, a keycap received in a corresponding through-hole of the enclosure 2 and movably connected to the switch, and a elastic member for restoring the keycap. The keycap 122 of the key 12 is received in the through-hole 22. The keycap 112 of the key 11 is received in the through-hole 24. A height of the switch of the key 11 is equal to that of the switch of the key 12. A top of the key 11 is higher than that of a top of the key 12.

Referring to FIG. 4, a game device in accordance with an alternative preferred embodiment of the present invention includes an enclosure 4, and three keys 41, 42, 43 mounted to the enclosure. A top of the key 41 is higher than a surface of the enclosure 4. Top of the keys 42, 43 is not higher than that of the surface of the enclosure 4.

Generally, a top of a commonly used key is higher than a surface of an enclosure of a game device, which may easily avoid mistakenly touch the other keys of the game device.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A game device, comprising:
an enclosure defining a first through-hole, and a second through-hole adjacent the first through hole in a surface thereof;
a first key received in the first through-hole, a top of the first key higher than the surface of the enclosure; and
a second key received in the second through-hole, a top of the second key lower than the surface of the enclosure.

2. The game device as claimed in claim 1, further comprising a circuit board mounted in the enclosure, wherein the first and second keys are electrically connected to the circuit board.

3. The game device as claimed in claim 2, wherein the first key comprises a first keycap, a top of the first keycap is higher than the surface of the enclosure.

4. The game device as claimed in claim 2, wherein the second key comprises a second keycap, a top of the second keycap is lower than the surface of the enclosure.

5. A game device, comprising:
an enclosure defining a first through-hole, and a second through-hole adjacent the first through hole in a surface thereof;
a first key received in the first through-hole, a top of the first key higher than the surface of the enclosure; and
a second key received in the second through-hole, a top of the second key aligned with the surface of the enclosure.

6. The game device as claimed in claim 5, further comprising a circuit board mounted in the enclosure, wherein the first and second keys are electrically connected to the circuit board.

7. The game device as claimed in claim 6, wherein the first key comprises a first keycap, a top of the first keycap is higher than the surface of the enclosure.

8. The game device as claimed in claim 6, wherein the second key comprises a second keycap, a top of the second keycap is aligned with the surface of the enclosure.
